(19) United States
(12) Patent Application Publication
(10) Pub. No.: US 2026/0225374 A1
(43) Pub. Date: Aug. 6, 2026

(54) FLUID RESERVOIR AND METHOD OF SUPPLYING A FLUID

(71) Applicant: XAAR TECHNOLOGY LIMITED, Huntingdon, Cambridgeshire (GB)

(72) Inventor: Christopher James GOSLING, Huntingdon, Cambridgeshire (GB)

(21) Appl. No.: 19/152,343

(22) PCT Filed: Jan. 29, 2024
(86) PCT No.: PCT/GB2024/050227

§ 371 Date: Jul. 30, 2025

(30) Foreign Application Priority Data
Jan. 30, 2023 (GB) 2301274.3

(51) Int. Cl. B41J 2/18; B41J 2/17; B41J 2/175; B41J 2/19

(52) U.S. Cl. CPC B41J 2/18; B41J 2/1707; B41J 2/17509; B41J 2/17553; B41J 2/17563; B41J 2/17566; B41J 2/17596; B41J 2/19

(57) ABSTRACT

A fluid reservoir for a fluid supply system for a recirculation droplet ejection head. The fluid supply system includes a fluid supply pump to transfer fluid from the fluid reservoir to the droplet ejection head, and a fluid return pump to transfer fluid away from the droplet ejection head and into the fluid reservoir. The fluid reservoir includes an outlet through which fluid is supplied to the droplet ejection head; and a return inlet through which fluid is received into the fluid reservoir. The fluid return inlet is arranged on a conical portion at a cross-section perpendicular to its main axis, and wherein the angle formed in the plane of the cross-section between the main axis of the fluid return inlet bore and a tangent to the cross-section, at the point where the cross-section is intersected by the fluid return inlet bore main axis, is not equal to 90°.

The present disclosure relates to a fluid reservoir for a fluid supply system and apparatus, a fluid supply system, and a method for supplying fluid, which may be particularly suitable for applications where fluids with a high particle content are supplied to a droplet ejection head to be ejected on a medium.

### BACKGROUND

Droplet ejection heads are now in widespread usage, whether in more traditional applications, such as inkjet printing, or in newer applications such as 3D printing. Droplet ejection heads have been developed that are capable of use in industrial applications, for example for printing directly onto substrates such as ceramic tiles or textiles. Such industrial printing techniques using droplet ejection heads (such as piezoelectric inkjet printheads) allow for short production runs, customization of products and even printing of bespoke designs. Droplet ejection heads continue to evolve and specialise so as to be suitable for new and/or increasingly challenging applications.

In recent years, there has been increasing interest in ejecting fluids with a high content of particles (such as up to 40 v/v %), for example, but not limited to, highly pigmented inks or glass frits. These kinds of fluids comprise solid particles (whose size may vary from a few nm to few μm) which are kept in suspension in a liquid medium like water or a solvent, for example with the aid of suitable molecules adsorbed on the particle surface. Fluids with high particle content may advantageously be applied to create three-dimensional features on media such as, but not limited to, ceramic tiles, flooring, furniture, architectural glass (and other glass objects to produce glass-on-glass decorations, e.g. on bottles), windscreens, mobile device screens, and the like. They can also be conveniently used to create three-dimensional objects, such as, but not limited to, moulds for metal or plastic casts. Other applications include printing high density and opaque images, or base layers, in a single pass. The use of fluids with high particle content allows the thickness of the wet layer in any fluid ejection application to be reduced thus reducing the duration of the drying step, the number of passes required to achieve the desired opacity or depth of colour and, in turn, energy consumption. It also allows the desired three-dimensional feature to be obtained with fewer passes of fluid ejection. This, in turn, contributes to decreased overall process times and costs and has a positive environmental impact through reduction of energy consumption, as well as amounts of solvents, humectants and the like. Further, the use of fluids with high particle content, in combination with fluid ejection techniques, allows for high flexibility and easy customisation of designs and improved colour gamut.

Fluids with high particle content may find wide application in many technical fields, including textile printing, Direct-to-Shape (DTS) applications (such as printing a swath exceeding 1 droplet ejection head width onto a bottle or other object), wide format graphics, coding and marking or packaging, and the like.

In most applications, some form of fluid delivery system is required to supply fluid to the droplet ejection head. The objective of the fluid delivery system may be limited to replenishing the fluid ejected by the droplet ejection head. More complex systems may require a controlled fluid flow rate through the droplet ejection head, since the fluid flow is used to, e.g., improve reliability of printing, to control the fluid temperature, or cool the droplet ejection head.

To ensure reliable performance of the droplet ejection head, it is desirable to maintain the fluid meniscus within the nozzles of the droplet ejection head so as to prevent fluid weeping onto a nozzle plate; in order to do this, the pressure inside the nozzle(s) of the droplet ejection head is kept below atmospheric pressure (e.g., at a negative pressure). This pressure is commonly referred to as back pressure, nozzle pressure or meniscus pressure. It is also desirable to prevent air being ingested into the droplet ejection head, which occurs when the back pressure is below a pre-defined value, such that the meniscus is drawn back into the nozzle(s) of the droplet ejection head. This lower limit on the back pressure may vary depending on the type of droplet ejection head and/or on the fluid being used. It may readily be determined by experimentation, for example.

The meniscus pressure must therefore be kept within a window which is generally determined by:
1) the meniscus pressure at which the fluid starts to weep onto the nozzle plate, and/or
2) the meniscus pressure at which air is ingested through the nozzles.

Some droplet ejection heads are so-called through-flow or recirculation droplet ejection heads. This means that the fluid circulates through the droplet ejection head with a proportion of the fluid being drawn off, and ejected out, of the nozzles and the remainder exiting the droplet ejection head and being returned to the fluid supply (for example, to a reservoir or to a pump to be re-circulated).

When using fluids with high particle content, it is important to ensure that the fluid maintains a sufficient degree of homogeneity, therefore, any separation of the suspended particles from the liquid medium should be minimised. A fluid as described herein, may be subject to particle separation, for example, while kept in a fluid reservoir which is a component of a fluid delivery system. The residence time of the fluid in the reservoir may be sufficient for the particles to start separating from the liquid medium with negative impact on the quality of the final decoration or product or image. In order to mitigate the particle separation, a fluid reservoir may be provided with a mechanical stirrer which constantly mixes or agitates the fluid thus keeping the particles in suspension. This solution is far from ideal especially when the fluid comprises abrasive particles, such as a glass frit. The repeated contact between the particles and the stirrer may damage the stirrer which may need to be frequently replaced causing increased maintenance and spare parts costs. Furthermore, using a stirrer adds to the overall energy consumption of the fluid delivery system.

The present invention has been devised in view of the above problems and provides an improved fluid reservoir for a recirculating fluid delivery system which is suitable to be used with fluids with a high particle content, such as highly pigmented fluids and glass frits and is capable of mitigating particle separation without requiring the use of a mechanical stirrer or other additional components subject to wear.

### SUMMARY OF THE INVENTION

Aspects of the invention are set out in the appended independent claims, while details of particular embodiments of the invention are set out in the appended dependent claims.

According to a first aspect of the invention, there is provided a fluid reservoir for a fluid supply system for a recirculation droplet ejection head, the fluid supply system comprising: a fluid supply pump having a fluid supply connection, fluidically connectable between the fluid reservoir and the droplet ejection head so as to transfer fluid from the fluid reservoir to the droplet ejection head; and a fluid return pump having a fluid return connection, fluidically connectable between the droplet ejection head and the fluid reservoir so as to transfer fluid away from the droplet ejection head and into the fluid reservoir; wherein the fluid reservoir comprises: a conical portion having a cross-section on a plane perpendicular to its main axis; a fluid outlet through which fluid is supplied from the fluid reservoir to the droplet ejection head via the fluid supply pump; and a fluid return inlet through which fluid is received from the droplet ejection head, via the fluid return pump, into the fluid reservoir, the fluid return inlet having a central bore with a main axis; wherein the fluid return inlet is arranged on the conical portion at the cross-section, and wherein the angle formed in the plane of the cross-section between the main axis of the fluid return inlet bore and a tangent to the cross-section, at the point where the cross-section is intersected by the fluid return inlet bore main axis, is not equal to 90° such that, in use, a component of the direction of flow of the fluid entering the conical portion is tangential to the cross-section to encourage flow of fluid around the conical portion.

According to a second aspect of the invention, there is provided a fluid supply system comprising the fluid reservoir according to the first aspect of the invention.

According to a third aspect of the invention, there is provided a method of supplying fluid to a recirculating droplet ejection apparatus via the fluid supply system of the second aspect, wherein the fluid comprises up to 40% v/v of solid particles having a D90 value less than or equal to 5 μm.

### BRIEF DESCRIPTION OF THE DRAWINGS

FIG. 1A depicts a fluid supply system comprising a fluid reservoir according to an embodiment of the invention;

FIG. 1B depicts a vertical cross-section of the conical portion of the fluid reservoir, according to an embodiment of the invention;

FIG. 2A depicts a cross-section of the conical portion of the fluid reservoir perpendicular to the main axis of the conical portion of FIG. 1B at the point where the main axis of the fluid return inlet intersects the conical portion;

FIG. 2B depicts the vector of the flow direction with a component on the tangent to the cross-section of FIG. 2A and a component along the radius of the cross-section of FIG. 2A;

FIGS. 2C and 2D depict the detail of the fluid return inlet at the point where it intersects the conical portion, according to two different embodiments of the invention;

FIGS. 3A and 3B depict the return inlet of the fluid reservoir according to two different embodiments of the invention;

FIG. 4A depicts the filling portion of the fluid reservoir according to an embodiment of the invention;

FIG. 4B depicts the filling portion of the fluid reservoir according to an embodiment of the invention; and

FIGS. 5A to 5D depict a vertical cross-section of the conical portion according to four different embodiments of the invention.

### DETAILED DESCRIPTION OF THE DRAWINGS

Embodiments and their various implementations will now be described with reference to the drawings. Throughout the following description, like reference numerals are used for like elements, where appropriate.

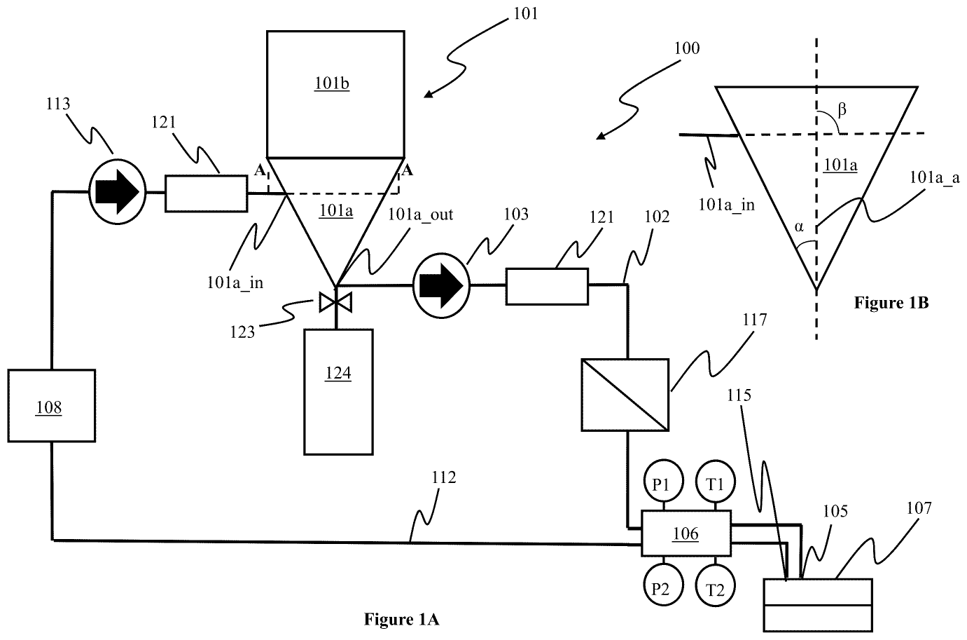

Considering first FIGS. 1A and 1B, this depicts a fluid delivery system 100 comprising a fluid reservoir 101 according to an embodiment of the invention. A fluid supply pump 103 has a fluid supply connection connectable between the fluid reservoir 101 and a droplet ejection head 107 via a fluid supply path 102, so as to transfer fluid from the fluid reservoir 101 to the droplet ejection head 107. A fluid return pump 113 has a fluid return connection, fluidically connectable between the droplet ejection head 107 and the fluid reservoir 101, so as to transfer fluid away from the droplet ejection head 107 and into the fluid reservoir 101, via a fluid return path 112.

The droplet ejection head 107 has a fluid inlet and a fluid outlet, and is, therefore, a recirculating or “through-flow” device. The droplet ejection head 107 may comprise a plurality of nozzles arranged in an array, for example, in one or more rows of nozzles extending in an array direction, through which droplets of fluid are ejected from one or more nozzles upon actuation of an actuator by an electrical signal. There may be a respective actuator associated with one or more respective nozzles so as to cause ejection of fluid via said one or more nozzles.

The fluid supply pump 103 is fluidically connectable to the reservoir 101 and fluidically connectable to the droplet ejection head 107, so as to connect to and supply fluid to the droplet ejection head 107.

FIG. 1A shows that the fluidic connection between the fluid supply pump 103 and the droplet ejection head 107, and the fluid supply pump 103 and the fluid reservoir 101, is via a fluid supply path 102. The fluid supply path 102 comprises a fluid supply connection 105 that is connectable to the inlet of the droplet ejection head 107. The fluid supply path 102 may comprise a plurality of sections and connectors to fluidically connect all the components located between the fluid reservoir 101 and the droplet ejection head 107.

The fluid return path 112 is fluidically connectable between the droplet ejection head 107 and the fluid return pump 113, and between the fluid return pump 113 and the fluid reservoir 101. The fluid return path 112 comprises a fluid return connection 115, that is connectable to the outlet of the droplet ejection head 107, so as to transfer fluid away from the droplet ejection head 107. The fluid return path 112 may comprise a plurality of sections and connectors to suitably fluidically connect all of the components located between the droplet ejection head 107 and the fluid reservoir 101. It may be understood that the fluid supply connection 105 and the fluid return connection 115 may be simple push fit connections onto the droplet ejection head 107, or they may be more complex connections, e.g., quick release self-sealing connectors. In some arrangements, a valve (not shown) may be included such that the droplet ejection head 107 may be removed without fluid spillage. Similar considerations may apply to any other connections required in the system.

The fluid supply system 100 may comprise a sensor manifold 106 which outputs the inlet pressure in the vicinity of the inlet or supply side of the droplet ejection head 107, pressure P_{S}=P1, and the pressure in the vicinity of the outlet or return side of the droplet ejection head 107, pressure P_{R}=P2, which may be used to determine the differential pressure P_{D} and the meniscus or nozzle or back pressure P_{M} using the following two equations, which calculation may be performed in a controller (not shown):

$${p}_{D} = {p}_{S} - {p}_{R}$$

$${p}_{M} = \frac{{p}_{S} + {p}_{R}}{2}$$

The differential pressure P_{D} is directly related to the flow rate through the droplet ejection head, the design of the droplet ejection head (impedance), and the viscosity of the fluid. The required flow rate depends on the droplet ejection head design, the type of fluid to be ejected, the application, and the print mode; a typical flow rate value may be 100 mL/min.

The fluid return pump 113 is operable to control the meniscus pressure P_{M} at the droplet ejection head 107, based on the output of the sensor manifold 106, so that the pressure at the nozzles remains within the allowable range of meniscus pressures (e.g., within the meniscus pressure window P_{M(WINDOW)}). In this way, there will be no ingestion of air or weeping of fluid from the nozzles in the droplet ejection head 107.

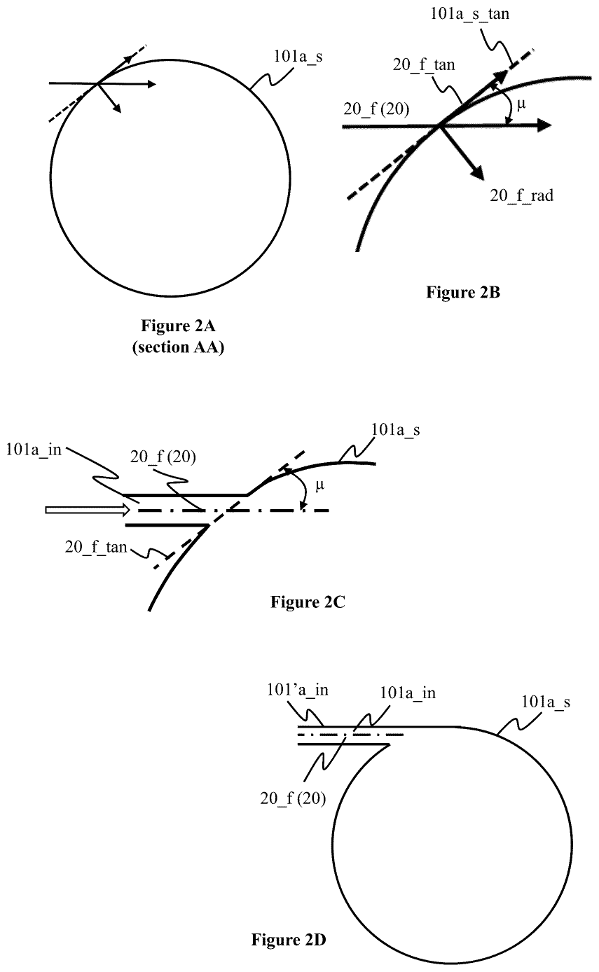

The fluid reservoir 101 has a conical portion 101a which has a cross section (101a_s, shown in FIG. 2A, indicated by the cross-section AA in FIG. 1A) on a plane perpendicular to its main axis 101a_a; a fluid outlet 101a_out through which fluid is supplied from the fluid reservoir 101 to the droplet ejection head 107, via the fluid supply pump 103, and a fluid return inlet 101a_in through which fluid is received from the droplet ejection head 107, via the fluid return pump 113, into the fluid reservoir 101. The fluid return inlet 101a_in has a central bore with a main axis 20 (see FIG. 2B to FIG. 2D). The fluid return inlet 101a_in is arranged on the conical portion 101a at the cross-section 101a_s.

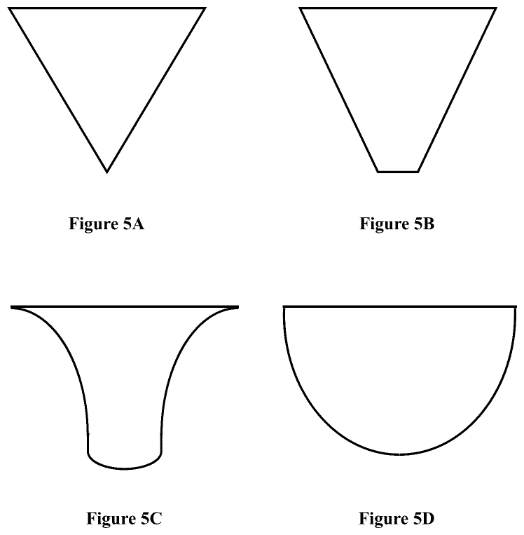

As used herein, “conical portion” means a portion which has a shape which is substantially an inverted cone, i.e., a hollow object which tapers from a circular or roughly circular (e.g., but not limited to, elliptical) base to a point (or vertex). It will be understood that the conical portion may have any shape which may be described as an inverted tapered body of revolution (non-limiting examples of which may be seen in FIG. 5A to FIG. 5D, as cross-sections) and that the taper may be linear or have any other suitable profile including a concave or convex profile or a segmented profile. It will further be understood that the conical portion may have a truncated shape, for example a frustoconical shape.

The cross-section 101a_s may have any suitable shape, as long as it is a closed curve. In some embodiments, the cross section 101a_s is substantially circular.

As used herein, the “conical portion main axis” is the vertical axis passing through the vertex (or virtual vertex for truncated shapes, i.e., the vertex of the corresponding non-truncated shape) of the conical portion.

As used herein, the “central bore main axis” is the axis parallel to the fluid flow direction in the fluid return flow path.

FIG. 2A to FIG. 2D show in detail the arrangement of the fluid return inlet 101a_in at the cross-section AA. The cross-section AA is indicated in FIG. 1A. As already mentioned, the fluid return inlet 101a_in has a central bore with a main axis 20; the main direction of the flow 20_f along the central bore may be parallel to the main axis 20. At the point where the fluid exits the bore into the conical portion 101a, the main direction of the flow 20_f may therefore be largely parallel to the main axis 20. The fluid return inlet 101a_in is arranged on the conical portion 101a at the cross section 101a_s so as to supply fluid to the conical portion 101a and such that, in the plane of the cross section 101a_s, the main axis 20 of the fluid return inlet bore 101a_in is at an angle μ to a tangent 101a_s_tan to the cross-section 101a_s. Where, at the point where the cross-section 101a_s is intersected by the fluid return inlet bore main axis 20, angle μ is not equal to 90°. In this way, in use, a component 20_f_tan of the direction of flow 20_f of the fluid entering the conical portion 101a is tangential to the cross-section 101a_s so as to encourage flow of fluid around the conical portion 101a, because the component 20_f_tan of the fluid flow direction 20_f is different from (not equal to) zero. The higher the magnitude (which may be referred to as the modulus) of the component 20_f_tan, the faster the flow of fluid around the conical portion 101a. As previously mentioned, the component 20_f_tan may be at an angle μ to the fluid return inlet bore main axis 20 (e.g., to the centre-line of the fluid return inlet 101a), where μ may be between 30° and 50°, preferably between 35° and 45°, more preferably between 37° and 41°, most preferably 39°.

In preferred embodiments, at least part of the outer edge 101′a_in of the fluid return inlet 101a_in bore is tangential to the cross-section 101a_s. Still further, in some preferred embodiments, the main axis 20 of the fluid return inlet bore may be parallel to the outer edge 101′a, as shown in FIG. 2D. This may be beneficial in enabling the fluid entering the conical portion 101a from the fluid return inlet 101a_in to stay attached to the convex surface (the Coanda effect), this may help to maximise the magnitude of the component 20_f_tan.

In other preferred embodiments (not shown), at least part of the inner edge of the of the fluid return inlet 101a_in bore is tangent to the cross-section 101a_s, and the main axis 20 of the fluid return inlet bore is parallel to the inner edge.

The cross-section of the return inlet 101a_in bore is not particularly limited. In some embodiments, the cross-section of the return inlet 101a_in bore may be substantially circular, in other embodiments, some or all of the bore may be rectangular, or slit-like, with a size in the direction of the conical portion main axis 101a_a larger than the size in the direction perpendicular to conical portion main axis 101a_a, so that a higher proportion of the fluid entering the conical portion 101a through the fluid return inlet 101a_in may be in direct contact with the inner surface of the conical portion 101a. Still further, the cross-sectional size and/or shape of the return inlet 101a may vary along the bore. For example, the bore may taper along its length, and/or the bore may change from a circular cross-section further away from the conical portion 101a to a slit-like shape adjacent to the conical portion 101a.

A vertical component to the fluid flow may also help to detrain any air bubbles that may be present and send them to the surface of the fluid in the fluid reservoir 101 from where the air may be removed, when a vent is present.

The component 20_f_rad, of the fluid flow direction 20_f, which is perpendicular to the component 20_f_tan may also be different from zero.

In some embodiments, the main axis 20 of the central bore of the fluid return inlet 101a_in forms an angle β substantially equal to 90° with the main axis 101a_a of the conical portion 101a (β=90°), which is the arrangement depicted in FIGS. 1A-1B and FIGS. 2A-2D. In some embodiments, the main axis 101a_a of the conical portion 101a is substantially vertical, and the main axis 20 of the central bore of the fluid return inlet 101a_in is substantially horizontal. In this context it will be understood that orientations that are very close to ‘vertical’ or ‘horizontal’ respectively and still achieve the intended purpose will be encompassed by the term ‘substantially’.

In other embodiments, the main axis 20 of the central bore of the fluid return inlet 101a_in forms an angle different from 90° with the main axis 101a_a of the conical portion 101a. In some embodiments, the main axis 101a_a of the conical portion 101a is substantially vertical, and the main axis 20 of the central bore of the fluid return inlet 101a_in is inclined relative to the horizontal.

It will be understood that, by controlling the flow of the fluid through the return inlet 101a_in, a flow can be established in the conical portion 101a which is, at least in part, tangential to the internal surface of the conical portion 101a and directed towards the bottom of the conical portion 101a, which could be thought of as a downward spiral-like path. This specific motion may help keeping the particles suspended in the liquid component of the fluid so that the deposition of the particles at the bottom of the reservoir 101 is minimised and the characteristics of the fluid are maintained sufficiently unaltered. As the person skilled in the art will understand, “sufficiently unaltered”, as used herein, means that the resulting droplet ejection performance and the image or product quality are acceptable for the specific application at hand.

It will be understood that the appropriate velocity of the fluid entering the conical portion 101a through the return fluid path 112, is set based on the fluid properties and the system requirements, such as the viscosity of the fluid, the meniscus pressure, the differential pressure, as well as on the specific application.

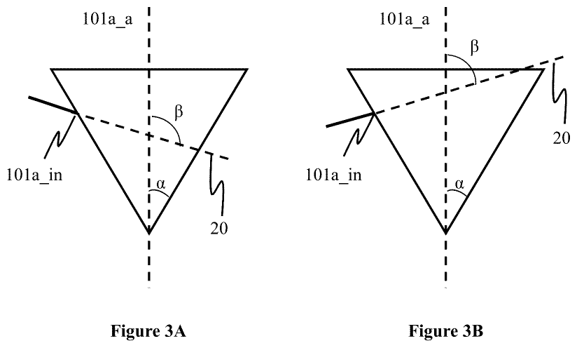

It will further be understood that the velocity of the fluid inside the conical portion 101a may be changed or optimised, as required, by inclining the fluid return inlet 101a_in of the conical portion 101a towards the top or the bottom of the fluid reservoir 101, as graphically shown in FIG. 3A and FIG. 3B. The angle of the main axis 20 relative to the main axis 101a_a of the conical portion 101a is denoted by angle β in FIG. 3A and FIG. 3B. Inclining the fluid return inlet 101a_in towards the larger region of the conical portion 101a, as seen in FIG. 3A, so that the angle β between the main axis 20 of the central bore of the fluid return inlet 101a_in and the conical portion main axis 101a_a is more than 90° (angle β>90°), may decrease the velocity of the fluid towards the bottom, i.e. the narrower region of the conical portion 101a; inclining the fluid return inlet 101a_in towards the narrower region, of the fluid reservoir 101, so that the angle β is less than 90° (angle β<90°), as shown in FIG. 3B, may increase the velocity of the fluid towards the bottom of the conical portion 101a. Angle β=90° is the arrangement depicted in FIG. 1A, for example, where the main axis 20 is perpendicular to the main axis 101a_a.

As the person skilled in the art will appreciate, the angle of inclination of the fluid return inlet 101a_in may be selected in accordance with one or more of the viscosity of the ink to be used with the system, the flow rate and the concentration of particles in the ink to be used with the system. For example, depending on the operating conditions, the values used for the angle β and the angle μ may be chosen so as to determine the direction at which the fluid enters the conical portion 101a from the fluid return inlet 101a_in.

The fluid return inlet 101a_in is arranged on the conical portion 101a_in a region where the cross-section 101a_s is wider compared to the cross-section of the region where the fluid outlet 101a_out is arranged. Preferably, the fluid return inlet 101a_in is arranged on the wider half of the conical portion 101a. Preferably, the fluid outlet 101a_out is arranged on the narrower half of the conical portion 101a. In this way, a spiral-like fluid path is created along which the separation of suspended particles from the liquid component of the fluid is minimised and the overall characteristics of the fluid are sufficiently unaltered when exiting the conical portion 101a through the fluid outlet 101a_out and into the supply path 102, so that it can be supplied to the droplet ejection head 107.

More preferably, the fluid outlet 101a_out is arranged on the conical portion 101a_in a region where the cross-section of the conical portion 101a is substantially the smallest. In this way, the occurrence of “blind spots” and corners in the conical portion 101a, below the fluid outlet 101a_out, where the suspended particles may separate from the liquid component of the fluid, is minimised. Further, in operation, the fluid is drawn, by the supply pump 103, from the point where the particles would tend to accumulate.

The angle of inclination α of the conical portion 101a (shown in FIG. 1), may be selected in accordance with one or more of the viscosity of the fluid to be used with the fluid delivery system 100, the flow rate and the concentration of particles in the fluid to be used with the fluid delivery system 100. For example, α may be in the range of 15° to 45°, preferably of 25° to 35°. The angle α may be 30°.

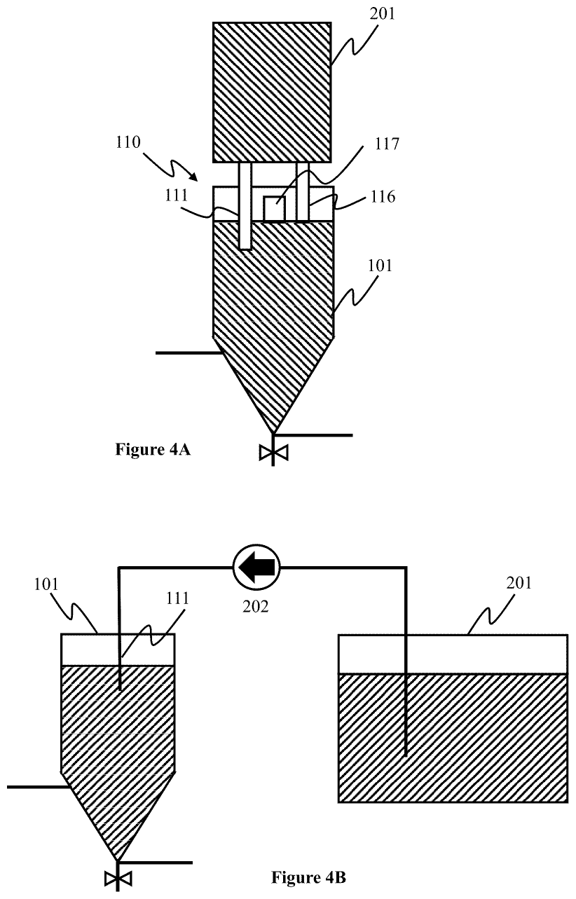

The fluid reservoir 101 may be provided with a filling portion 110 to supply fresh fluid to the fluid reservoir 101. The filling portion 110 may comprise a fresh fluid inlet, for example a fresh fluid inlet pipe 111, connectable to an external fluid tank 201, to supply fresh fluid to the fluid reservoir 101. FIGS. 4A and 4B show two different arrangements of the fluid tank 201. In some embodiments, as shown in FIG. 4A, a fresh fluid inlet pipe 111 may be directly connected to the external fluid tank 201. In some instances, the fluid reservoir 101 may be further provided with a vent, for example a vent pipe 116. In some embodiments, the filling portion 110 may be arranged to supply fresh fluid to the fluid reservoir 101 by gravity. Initially, fluid may be added from the tank 201 to the fluid reservoir 101 through the fresh fluid inlet pipe 111. As long as the vent tube 116 is not in contact with the fluid in the reservoir 101, fluid will flow from the tank 201, through the fresh fluid inlet pipe 111, to the reservoir 101, while air is released from the fluid reservoir 101 to the tank 201, through the vent pipe 116. As soon as the level of the fluid reaches the opening of the vent pipe 116 and plugs it, air stops flowing from the fluid reservoir 101 to the tank 201 and fluid stops flowing from the tank 201 to the reservoir 101.

When the fluid supply system 100 is in use, fluid will flow to the droplet ejection head 107, with a portion of the fluid being ejected and the remainder flowing from the droplet ejection head 107 back to the fluid reservoir 101 causing fluid to progressively leave the fluid reservoir 101 over time. As fluid is consumed by being ejected through the droplet ejection head 107, the level of the fluid inside the fluid reservoir 101 will be kept constant by replenishing with the fresh fluid flowing from the external tank 201. The fresh fluid entering the fluid reservoir 101 will be immediately mixed with the fluid already present in the fluid reservoir 101. In this way the conditions experienced by the fluid in the fluid tank 101 will be substantially constant so allowing a reliable ejection of fluid droplets from the nozzles of the droplet ejection head 107. The fluid exiting the droplet ejection head 107 will be returned to the conical portion 101a of the fluid reservoir 101 where it will mix with the ink present in the ink reservoir 101, which has already mixed with the fresh fluid. In this way, the volume of fluid ejected will be readily replaced by fresh fluid and the mixing of the fresh fluid with the fluid already present in the fluid reservoir 101 will ensure that the characteristics of the fluid will be sufficiently unaltered for the duration of the use.

In other embodiments, as depicted in FIG. 4B, the fresh fluid inlet is connectable to a filling pump 202 which is, in turn, connectable to the tank 201. The filling pump 201 may be provided as part of the fluid supply system 100, in some embodiments. In other embodiments the filling pump 202 may be an external device.

It will be understood that any other suitable arrangement known in the art may be used to refill the fluid reservoir 101 with fresh fluid.

Preferably, the fluid reservoir 101 is also provided with a level sensor 117 so that, if the refilling of the fluid reservoir 101 with fresh fluid stops because the tank 201 is empty, a warning is given to the user.

As the person skilled in the art will appreciate, the fluid reservoir 101 may also be a single use fluid reservoir which is not meant to be refilled and can be conveniently used for very short applications or with comparatively unstable fluid compositions.

The fluid reservoir 101 may further comprise a discharge portion 123, including a discharge outlet, for drawing fluid out of the fluid reservoir 101. This avoids fluid stagnating in the fluid reservoir 101 when the fluid delivery system is not in use therefore avoiding separation of the particles present in the fluid which would happen if the fluid were static. The fluid exiting the fluid reservoir 101 may be collected in a drain container 124 (shown in FIG. 1A) and possibly reused. The drain bottle and/or the external tank 201 may be kept in a suitable agitation device between successive uses, so as to avoid separation of the particles.

The discharge portion 123 may, for example, comprise a valve, preferably a solenoid valve. As the person skilled in the art will appreciate, any other flow control device, or arrangement of devices known in the art, other than a valve, can be used to draw fluid from the fluid reservoir 101. In other embodiments, the discharge portion 123 is simply an outlet, which is connectable to suitable fluid discharge device(s) provided as part of the fluid supply system 100. The drawings show the discharge portion 123 located at the bottom of the fluid reservoir 101 but this is by no means limiting.

The fluid delivery system 100 of the invention, comprises the fluid reservoir 101 as described above.

The fluid supply system 100 may further comprise a damping system 108 to even out any pressure fluctuations in the fluidic path (supply and/or return) and, thereby, improve ejection performance. The supply and or the return pumps 103, 113, may have a fluid damper 108, adjacent to them. It may be understood that damping systems or dampers are not required in all circumstances, it depends on factors such as the required ejection quality, the type of pumps used, the performance of the chosen pumps and the configuration of the fluid supply system. It may further be understood that, provided pressure pulses are sufficiently damped (typically to below +/−2 mbar) the fluid supply 103 and/or fluid return 113 pumps need not be located adjacent to the droplet ejection heads 107, which may be advantageous for weight considerations in some applications.

In some embodiments, the fluid supply system 100 comprises one or more restrictors 121 to further improve control of pressure pulses in the fluid path (supply and/or return), in addition to or instead of a damping system 108.

The fluid delivery system 100 may further comprise a sensor manifold 106, as discussed above.

The sensor manifold 106 may further comprise temperature sensors to measure the temperature in the vicinity of the inlet or supply side of the droplet ejection head 107, temperature T1, and the temperature in the vicinity of the outlet or return side of the droplet ejection head 107, temperature T2. The temperature measurements may be used to ensure that the temperature (and hence viscosity) of the fluid, such as ink, is controlled.

The fluid supply system 100 may also be provided with one or more conditioning devices (not shown). Examples of conditioning devices include one or more fluid conditioning apparatus, such as a temperature control apparatus (e.g., a heater, or a cooler), de-gassers and the like.

The temperature sensors of the sensor manifold 106 (when present), may be used in a controller (not shown) to provide feedback in a temperature control loop. Such a temperature control loop may comprise a temperature control device such as a heater, or a cooler. A change in the temperature of the fluid would typically change its viscosity and therefore the differential pressure in the system. The use of a temperature control loop and a temperature control device may allow the temperature of the ink to be controlled such that the performance of one or more of the pumps does not have to be adjusted to account for temperature variations.

A further control loop may use the average of the inlet and outlet temperatures (T2+T1)/2 across the droplet ejection head 107 to adjust the print duty cycle, for example to reduce the duty cycle, if the temperature rise is too great.

The fluid supply system 100 may also comprise a filter 117 to block external unwanted bodies or conglomerates of particles from reaching the droplet ejection head 107 and potentially cause blockages and/or poor ejection performances.

The droplet ejection head 107 is suitable for use in any recirculating droplet ejection apparatus and the fluid supply system 100 of the invention may reliably provide, to a recirculating droplet ejection apparatus, a fluid comprising up to 40% v/v of solid particles having a particle size distribution D90 value less than or equal to 5 μm, which means that 90% of the particles dispersed in the fluid have a particle size up to 5 μm.

The fluid supply system 100 of the invention may provide fluid to one or more droplet ejection heads 107, it may supply a plurality of droplet ejection heads 107, the number of droplet ejection heads 107 may be dependent on the fluid recirculation rate and the flow rate achievable by the pumps for a given fluid.

The embodiments and their variants described above may be used alone or in combination, as dictated by the specific application requirements.

1. A fluid reservoir for a fluid supply system for a recirculation droplet ejection head, the fluid supply system comprising:
a fluid supply pump having a fluid supply connection, fluidically connectable between the fluid reservoir and the droplet ejection head so as to transfer fluid from the fluid reservoir to the droplet ejection head; and
a fluid return pump having a fluid return connection, fluidically connectable between the droplet ejection head and the fluid reservoir so as to transfer fluid away from the droplet ejection head and into the fluid reservoir;
wherein the fluid reservoir includes:
a) a conical portion having a cross-section on a plane perpendicular to its main axis;
b) a fluid outlet through which fluid is supplied from the fluid reservoir to the droplet ejection head via the fluid supply pump; and
c) a fluid return inlet through which fluid is received from the droplet ejection head via the fluid return pump into the fluid reservoir; the fluid return inlet having a central bore with a main axis;
wherein the fluid return inlet is arranged on the conical portion at the cross section, and wherein the angle formed in the plane of the cross-section between the main axis of the fluid return inlet bore and a tangent to the cross-section, at the point where the cross-section is intersected by the fluid return inlet bore main axis, is not equal to 90 degrees such that, in use, a component of the direction of flow of the fluid entering the conical portion is tangential to the cross-section to encourage flow of fluid around the conical portion.

2. The fluid reservoir according to claim 1, wherein the cross-section of the conical portion is substantially circular.

3. The fluid reservoir according to claim 1, wherein the main axis of the central bore of the fluid return inlet forms an angle substantially equal to 90° with the main axis of the conical portion.

4. The fluid reservoir according to claim 3, wherein the main axis of the conical portion is substantially vertical, and the main axis of the central bore of the fluid return inlet is substantially horizontal.

5. The fluid reservoir according to claim 1, wherein the main axis of the central bore of the fluid return inlet forms an angle different from 90° with the main axis of the conical portion.

6. The fluid reservoir according to claim 5, wherein the main axis of the conical portion is substantially vertical, and the main axis of the central bore of the fluid return inlet is inclined relative to the horizontal.

7. The fluid reservoir according to claim 6, wherein the angle of inclination of the fluid return inlet is selected in accordance with one or more of the following:
a) the viscosity of the ink to be used with the system;
b) the flow rate; and
c) the concentration of particles in the fluid to be used with the system.

8. The fluid reservoir according to claim 1, wherein the fluid return inlet is arranged on the wider half of the conical portion.

9. The fluid reservoir according to claim 1, wherein the fluid outlet is arranged on the narrower half of the conical portion.

10. The fluid reservoir according to claim 1, wherein the fluid outlet is arranged on the conical portion in a region where the cross-section of the conical portion is substantially the smallest.

11. The fluid reservoir according to claim 1, further comprising:
a fresh fluid inlet connectable to an external fluid tank to supply fresh fluid to the fluid reservoir; and/or
a vent; and/or
a level sensor.

12. (canceled)

13. (canceled)

14. The fluid reservoir according to claim 1, further comprising a discharge portion for drawing fluid out of the fluid reservoir.

15. The fluid reservoir according to claim 14, wherein the discharge portion includes a valve, preferably a solenoid valve.

16. The fluid reservoir according to claim 1, wherein the angle of inclination of the conical portion is selected in accordance with one or more of the following:
a) the viscosity of the fluid to be used with the fluid delivery system;
b) the flow rate; and
c) the concentration of particles in the fluid to be used with the fluid delivery system.

17. The fluid reservoir according to claim 16, wherein the angle of inclination of the conical portion is in the range of 150 to 45°.

18. A fluid supply system for a recirculation droplet ejection head, the fluid supply system comprising:
the fluid reservoir according to claim 1;
a fluid supply pump having a fluid supply connection, fluidically connectable between the fluid reservoir and the droplet ejection head so as to transfer fluid from the fluid reservoir to the droplet ejection head; and
a fluid return pump having a fluid return connection, fluidically connectable between the droplet ejection head and the fluid reservoir so as to transfer fluid away from the droplet ejection head and into the fluid reservoir.

19. The fluid supply system according to claim 18, further comprising:
a damping system; and/or
a restrictor; and/or
a fluid temperature control apparatus; and/or
a sensor manifold.

20. (canceled)

21. (canceled)

22. (canceled)

23. The fluid supply system according to claim 18, further comprising a filter.

24. The fluid supply system according to claim 18, comprising a filling pump connectable between the fluid reservoir and an external fluid tank for supplying fresh fluid from the external fluid tank to the fluid reservoir.

25. A method of supplying fluid to a recirculating printing apparatus via the fluid supply system according to claim 18, wherein the fluid comprises up to 40% v/v of solid particles having a D90 value less than or equal to 5 μm.
